(19) United States
(12) Patent Application Publication
(10) Pub. No.: US 2010/0146529 A1
(43) Pub. Date: Jun. 10, 2010

(54) INCIDENT REPORTING IN A MULTIMEDIA CONTENT DISTRIBUTION NETWORK

(75) Inventors: Jon D. Heath, Lees Summit, MO (US); James Huffman, Kansas City, MO (US); Brian Wilson, Liberty, MO (US)

Correspondence Address: AT&T Legal Department - JW;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/328,968

(22) Filed: Dec. 5, 2008

(51) Int. Cl. H04H 60/32

(52) U.S. Cl. 725/14; 725/9

(57) ABSTRACT

A method and system for reporting incidents on a multimedia content distribution network (MCDN) includes generating user service alerts when a disruption to a channel of the multimedia content is observed. The user service alert may be generated at a client of the MCDN and recorded along with a timestamp and a channel indicator. A remote control device may be equipped to generate the user service alert. A support event may be generated in response to receiving the user service alert. The support event may cause the disruption to be investigated and a status report to be sent back to the client.

### BACKGROUND

1. Field of the Disclosure

The present disclosure relates to multimedia content distribution networks (MCDN) and, more particularly, to incident reporting in an MCDN.

2. Description of the Related Art

A viewer of multimedia content from an MCDN may observe a difficulty with the MCDN service, such as an interruption or a degradation of the multimedia content stream. When this happens, the viewer typically calls the MCDN service provider to report the difficulty.

### BRIEF DESCRIPTION OF THE DRAWINGS

FIG. 1 is a block diagram of selected elements of an embodiment of a multimedia distribution network;

FIG. 2 is a block diagram of selected elements of an embodiment of a multimedia distribution network;

FIG. 3 is a block diagram of selected elements of an embodiment of a multimedia handling device;

FIG. 4 illustrates an embodiment of a method for incident reporting; and

FIG. 5 illustrates an embodiment of a method for incident reporting.

### DESCRIPTION OF EXEMPLARY EMBODIMENTS

A client of the MCDN may employ a decoding device to provide desired programming to a user. The user may select a primary viewing channel to receive and display a desired program. When a disruption of the viewing channel occurs, the desired program may not be viewable. As used herein, a “disruption” refers to a degradation or outage of the display of multimedia content. A disruption may be temporary (i.e., transient) or may last for a longer duration. As used herein, an “incident” refers to a disruption event occurring during viewing of multimedia content.

The cause, or origin, of the disruption may lie with an MCDN service provider, an access network, or an MCDN client system. The disruption may be caused internally within the MCDN or externally, for example, by environmental influences. As such, a disruption may affect a single MCDN client, or may be common to a number of MCDN clients.

The user may choose to ignore the disruption if an available method of reporting such an incident is time-consuming and/or inconvenient. If the user does not report an incident, the MCDN service provider may remain unaware of the incident. As is described herein, an MCDN may be configured with an automated, electronic incident reporting, which may allow users to immediately react to a perceived disruption of MCDN service. As disclosed herein, a method and system for incident reporting may facilitate enhanced support functionality to be provided to users of an MCDN, and may increase incident monitoring and tracking capabilities.

In one aspect, a disclosed method for reporting incidents over an MCDN includes receiving multimedia content from the MCDN, displaying the multimedia content, receiving a user service alert indicative of a disruption of the multimedia content, and causing a timestamp indicative of when the user service alert was received to be recorded. In response to said receiving the user service alert, the method may further include triggering an MCDN support event, including sending a notification of the user service alert, a channel of the multimedia content, and the timestamp. The triggering may include notifying an MCDN server.

In some embodiments, user input may be received from a remote control device configured to send an indication of a desired channel for viewing. Responsive to the user input, the method may further include selecting the desired channel from a plurality of channels available or associated with the multimedia content. The remote control device may be configured to operate with an electronic programming guide (EPG) for viewing and selecting multimedia content available from the MCDN. Receiving the user service alert may include receiving a response to a menu option in the EPG. The user service alert may be received from a remote control device. The remote control device may be a wireless communications device, while the user service alert may be wirelessly received.

In a further aspect, a disclosed system for generating support events over an MCDN includes a processor, and memory media accessible to the processor, including processor executable instructions. The instructions may be executable to send multimedia content to a client of the MCDN, including a plurality of viewing channels, receive a service request via the MCDN from the client indicating a disruption of a viewing channel from the plurality of viewing channels, and generate a support event based on the service request. The service request may be based on user input received by the client.

In some cases, the system may include processor executable instructions to send a confirmation to the client that the support event has been generated. The system may further include processor executable instructions to store information about the service request. The information may include at least one of information indicating a network identity of the client and information indicating an identity of the user. The service request may include information specifying the viewing channel and a timestamp indicative of when the service request was received. The service request may include information specifying the viewing channel and a timestamp indicative of when the service request was received. The instructions to generate the support event may include instructions executable to cause an MCDN service provider to perform a network diagnosis routine for the disruption. In some cases, the network diagnosis routine may include querying packet routing devices on the MCDN.

In certain embodiments, the system may include processor executable instructions to confirm the validity of the service request, wherein information for the viewing channel is compared with the service request. The information for the viewing channel may include information collected from a plurality of clients of the MCDN.

In yet another aspect, a disclosed computer-readable memory media includes executable instructions for delivering multimedia content over an MCDN. The instructions may be executable to respond to a user service alert indicating a disruption of a viewing channel by generating a support event, wherein the viewing channel is one of a plurality of viewing channels made available to a client of the MCDN, and output a confirmation of the support event to the client. The user service alert may include information specifying the viewing channel and a timestamp indicative of when the user service alert was received. The instructions to respond to the user service alert may include instructions executable to cause an MCDN service provider to perform a network diagnosis routine for the disruption.

The memory media may further include instructions executable to output status information for the network diagnosis routine to the client. The instructions to respond to the user service alert may include instructions executable to contact a user of the client. The instructions executable to contact the user of the client may include instructions executable to send a text message to the user. The instructions executable to contact the user of the client may include instructions executable to initiate a telephone call to the user.

In the following description, details are set forth by way of example to facilitate discussion of the disclosed subject matter. It should be apparent to a person of ordinary skill in the field, however, that the disclosed embodiments are exemplary and not exhaustive of all possible embodiments.

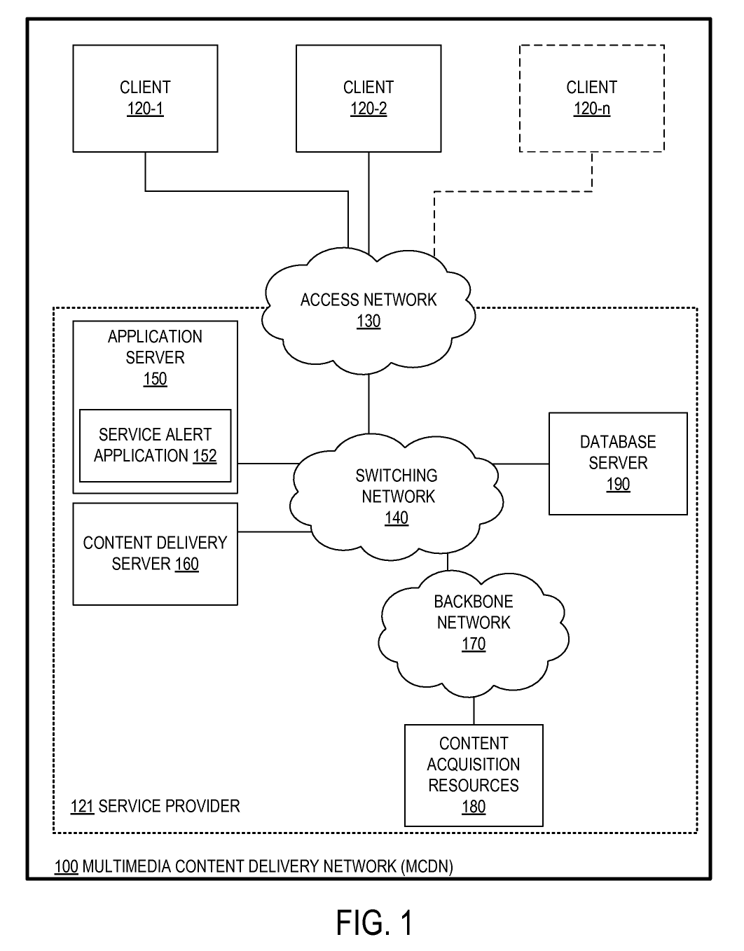

Turning now to the drawings, FIG. 1 is a block diagram illustrating selected elements of an embodiment of MCDN 100. Although multimedia content is not limited to TV, video on demand (VOD), or pay-per-view (PPV) programs, the depicted embodiments of MCDN 100 and its capabilities are primarily described herein with reference to these types of multimedia content, which are interchangeably referred to herein as multimedia content, multimedia content program(s), multimedia programs or, simply, programs.

The elements of MCDN 100 illustrated in FIG. 1 depict network embodiments with functionality for delivering multimedia content to a set of one or more subscribers. It is noted that different embodiments of MCDN 100 may include additional elements or systems (not shown in FIG. 1 for clarity) as desired for additional functionality, such as data processing systems for billing, content management, customer support, operational support, or other business applications.

As depicted in FIG. 1, MCDN 100 includes one or more clients 120 and a service provider 121. Each client 120 may represent a different subscriber of MCDN 100. In FIG. 1, a plurality of n clients 120 is depicted as client 120-1, client 120-2 to client 120-n, where n may be a large number. Service provider 121 as depicted in FIG. 1 encompasses resources to acquire, process, and deliver programs to clients 120 via access network 130. Such elements in FIG. 1 of service provider 121 include content acquisition resources 180 connected to switching network 140 via backbone network 170, as well as application server 150, database server 190, and content delivery server 160, also shown connected to switching network 140.

Access network 130 demarcates clients 120 and service provider 121, and provides at least one connection path between clients 120 and service provider 121. In some embodiments, access network 130 is an Internet protocol (IP) compliant network. In some embodiments, access network 130 is, at least in part, a coaxial cable network. It is noted that in some embodiments of MCDN 100, access network 130 is owned and/or operated by service provider 121. In other embodiments, a third party may own and/or operate at least a portion of access network 130.

In IP-compliant embodiments of access network 130, access network 130 may include a physical layer of unshielded twist pair cables, fiber optic cables, or a combination thereof MCDN 100 may include digital subscribe line (DSL) compliant twisted pair connections between clients 120 and a node (not depicted) in access network 130 while fiber, cable or another broadband medium connects service provider resources to the node. In other embodiments, the broadband cable may extend all the way to clients 120.

As depicted in FIG. 1, switching network 140 provides connectivity for service provider 121, and may be housed in a central office or other facility of service provider 121. Switching network 140 may provide firewall and routing functions to demarcate access network 130 from the resources of service provider 121. In embodiments that employ DSL compliant connections, switching network 140 may include elements of a DSL Access Multiplexer (DSLAM) that multiplexes many subscriber DSLs to backbone network 170.

In FIG. 1, backbone network 170 represents a private network including, as an example, a fiber based network to accommodate high data transfer rates. Content acquisition resources 180 as depicted in FIG. 1 encompass the acquisition of various types of content including broadcast content, other “live” content including national content feeds, and VOD content.

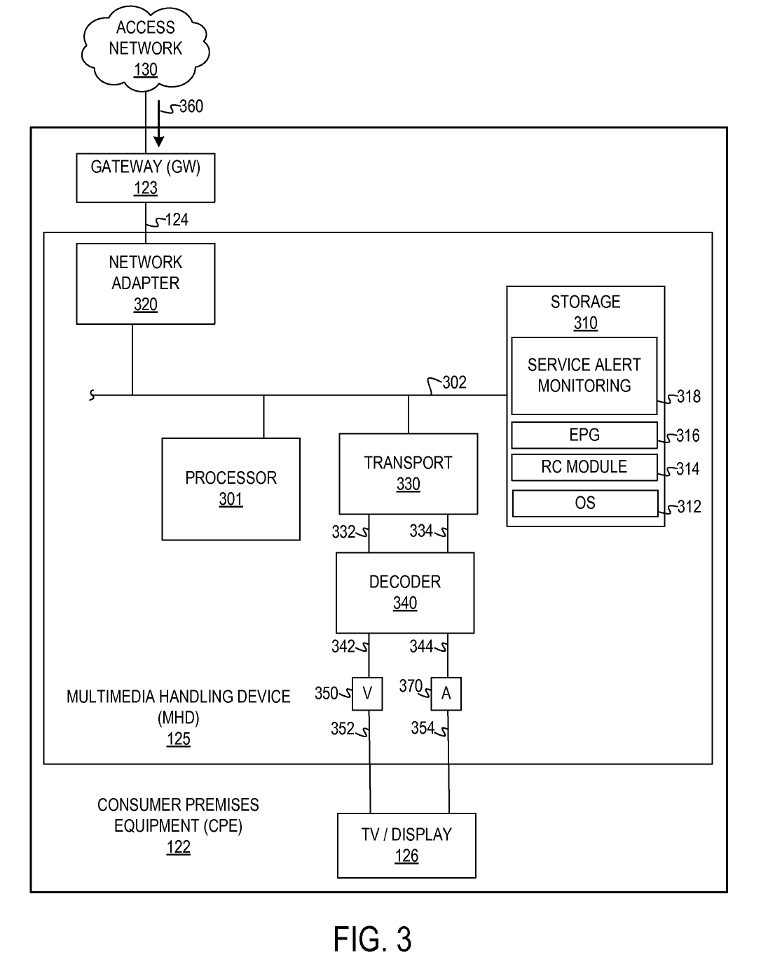

Thus, the content provided by service provider 121 encompasses multimedia content that is scheduled in advance for viewing by clients 120 via access network 130. Such multimedia content, also referred to herein as “scheduled programming,” may be selected using an electronic programming guide (EPG), such as EPG 316 described below with respect to FIG. 3. Accordingly, a user of MCDN 100 may be able to browse scheduled programming well in advance of the broadcast date and time. Some scheduled programs may be “regularly” scheduled programs, which recur at regular intervals or at the same periodic date and time (i.e., daily, weekly, monthly, etc.). Programs which are broadcast at short notice or interrupt scheduled programs are referred to herein as “unscheduled programming.”

Acquired content is provided to content delivery server 160 via backbone network 170 and switching network 140. Content may be delivered from content delivery server 160 to clients 120 via switching network 140 and access network 130. Content may be compressed, encrypted, modulated, demodulated, and otherwise encoded or processed at content acquisition resources 180, content delivery server 160, or both. Although FIG. 1 depicts a single element encompassing acquisition of all content, different types of content may be acquired via different types of acquisition resources. Similarly, although FIG. 1 depicts a single content delivery server 160, different types of content may be delivered by different servers. Moreover, embodiments of MCDN 100 may include content acquisition resources in regional offices that are connected to switching network 140.

Although service provider 121 is depicted in FIG. 1 as having switching network 140 to which content acquisition resources 180, content delivery server 160, and application server 150 are connected, other embodiments may employ different switching networks for each of these functional components and may include additional functional components (not depicted in FIG. 1) including, for example, operational subsystem support (OSS) resources.

FIG. 1 also illustrates application server 150 connected to switching network 140. As suggested by its name, application server 150 may host or otherwise implement one or more applications for multimedia content delivery network 100. Application server 150 may be any data processing system with associated software that provides applications for clients or users. Application server 150 may provide services including multimedia content services, e.g., EPGs, digital video recording (DVR) services, VOD programs, PPV programs, IPTV portals, digital rights management (DRM) servers, navigation/middleware servers, conditional access systems (CAS), and remote diagnostics, as examples.

Applications provided by application server 150 may be downloaded and hosted on other network resources including, for example, content delivery server 160, switching network 140, and/or on clients 120. Application server 150 is configured with a processor and storage media (not shown in FIG. 1) and is enabled to execute processor instructions, such as those included within a software application. As depicted in FIG. 1, application server 150 may be configured to include service alert application 152, which, as will be described in detail below, is configured to respond to user service alerts indicating disruptions of desired programs included in the multimedia content provided to client 120 of MCDN 100.

Further depicted in FIG. 1 is database server 190, which provides hardware and software resources for data warehousing. Database server 190 may communicate with other elements of the resources of service provider 121, such as application server 150 or content delivery server 160, in order to store and provide access to large volumes of data, information, or multimedia content. In some embodiments, database server 190 includes a data warehousing application, accessible via switching network 140, that can be used to record and access structured data, such as program or channel metadata for clients 120.

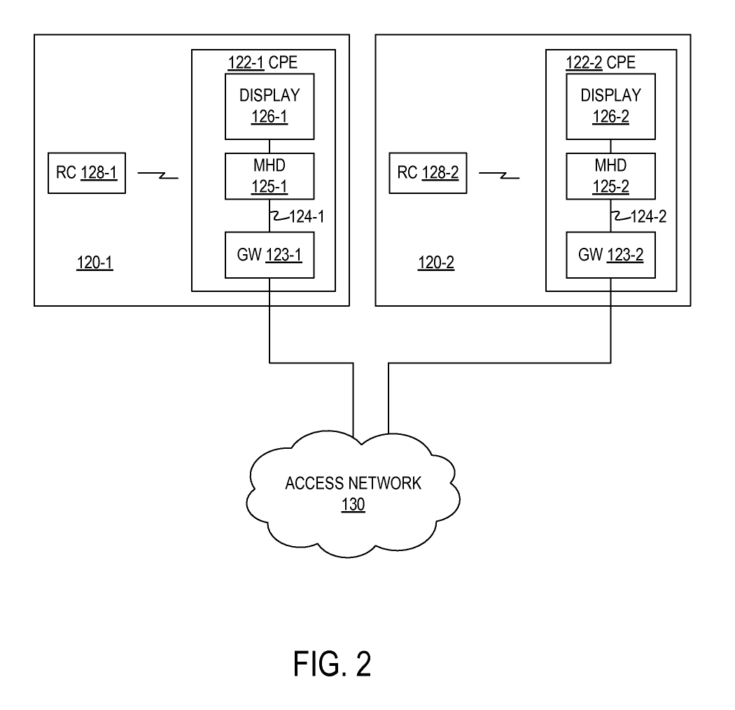

Turning now to FIG. 2, clients 120 are shown in additional detail with respect to access network 130. Clients 120 may include a network appliances collectively referred to herein as client premises equipment (CPE) 122. In the depicted embodiment, CPE 122 includes the following devices: gateway (GW) 123, multimedia handling device (MHD) 125, and display device 126. Any combination of GW 123, MHD 125, and display device 126 may be integrated into a single physical device. Thus, for example, CPE 122 might include a single physical device that integrates GW 123, MHD 125, and display device 126. As another example, MHD 125 may be integrated into display device 126, while GW 123 is housed within a physically separate device.

In FIG. 2, GW 123 provides connectivity for client 120 to access network 130. GW 123 provides an interface and conversion function between access network 130 and client-side local area network (LAN) 124. GW 123 may include elements of a conventional DSL or cable modem. GW 123, in some embodiments, may further include routing functionality for routing multimedia content, conventional data content, or a combination of both in compliance with IP or another network layer protocol. In some embodiments, LAN 124 may encompass or represent an IEEE 802.3 (Ethernet) LAN, an IEEE 802.11-type (WiFi) LAN, or a combination thereof. GW 123 may still further include WiFi or another type of wireless access point to extend LAN 124 to wireless-capable devices in proximity to GW 123. GW 123 may also provide a firewall (not depicted) between clients 120 and access network 130.

Clients 120 as depicted in FIG. 2 further include a display device or, more simply, a display 126. Display 126 may be implemented as a TV, a liquid crystal display screen, a computer monitor, or the like. Display 126 may comply with a display standard such as National Television System Committee (NTSC), Phase Alternating Line (PAL), or another suitable standard. Display 126 may include one or more integrated speakers to play audio content.

Clients 120 are further shown with their respective remote control 128, which is configured to control the operation of MHD 125 by means of a user interface (not shown in FIG. 2) displayed on display 126. Remote control 128 of client 120 is operable to communicate requests or commands wirelessly to MHD 125 using infrared (IR) or radio frequency (RF) signals. MHDs 125 may also receive requests or commands via buttons (not depicted) located on side panels of MHDs 125.

MHD 125 is enabled and configured to process incoming multimedia signals to produce audio and visual signals suitable for delivery to display 126 and any optional external speakers (not depicted). Incoming multimedia signals received by MHD 125 may be compressed and/or encrypted, digital or analog, packetized for delivery over packet switched embodiments of access network 130 or modulated for delivery over cable-based access networks. In some embodiments, MHD 125 may be implemented as a stand-alone set top box suitable for use in a co-axial or IP-based multimedia content delivery network.

Referring now to FIG. 3, a block diagram illustrating selected elements of an embodiment of MHD 125 is presented. In FIG. 3, MHD 125 is shown as a functional component of CPE 122 along with GW 123 and display 126, independent of any physical implementation, as discussed above with respect to FIG. 2. In particular, it is noted that CPE 122 may be any combination of GW 123, MHD 125 and display 126.

In the embodiment depicted in FIG. 3, MHD 125 includes processor 301 coupled via shared bus 302 to storage media collectively identified as storage 310. MHD 125, as depicted in FIG. 3, further includes network adapter 320 that interfaces MHD 125 to LAN 124 and through which MHD 125 receives multimedia content 360. GW 123 is shown providing a bridge between access network 130 and LAN 124, and receiving multimedia content 360 from access network 130.

In embodiments suitable for use in IP based content delivery networks, MHD 125, as depicted in FIG. 3, may include transport unit 330 that assembles the payloads from a sequence or set of network packets into a stream of multimedia content. In coaxial based access networks, content may be delivered as a stream that is not packet based and it may not be necessary in these embodiments to include transport unit 330. In a co-axial implementation, however, clients 120 may require tuning resources (not explicitly depicted in FIG. 3) to “filter” desired content from other content that is delivered over the coaxial medium simultaneously and these tuners may be provided in MHDs 125. The stream of multimedia content received by transport unit 330 may include audio information and video information and transport unit 330 may parse or segregate the two to generate video stream 332 and audio stream 334 as shown.

Video and audio streams 332 and 334, as output from transport unit 330, may include audio or video information that is compressed, encrypted, or both. A decoder unit 340 is shown as receiving video and audio streams 332 and 334 and generating native format video and audio streams 342 and 344. Decoder 340 may employ any of various widely distributed video decoding algorithms including any of the Motion Pictures Expert Group (MPEG) standards, or Windows Media Video (WMV) standards including WMV 9, which has been standardized as Video Codec-1 (VC-1) by the Society of Motion Picture and Television Engineers. Similarly decoder 340 may employ any of various audio decoding algorithms including Dolby® Digital, Digital Theatre System (DTS) Coherent Acoustics, and Windows Media Audio (WMA).

The native format video and audio streams 342 and 344 as shown in FIG. 3 may be processed by encoders/digital-to-analog converters (encoders/DACs) 350 and 370 respectively to produce analog video and audio signals 352 and 354 in a format compliant with display 126, which itself may not be a part of MHD 125. Display 126 may comply with NTSC, PAL or any other suitable television standard.

Storage 310 encompasses persistent and volatile media, fixed and removable media, and magnetic and semiconductor media. Storage 310 is operable to store instructions, data, or both. Storage 310 as shown may include sets or sequences of instructions, namely, an operating system 312, a remote control application program identified as RC module 314, EPG 316, and service alert monitoring 318. Operating system 312 may be a UNIX or UNIX-like operating system, a Windows® family operating system, or another suitable operating system. In some embodiments, storage 310 is configured to store and execute instructions provided as services to client 120 by application server 150, as mentioned previously.

EPG 316 represents a guide to the multimedia content provided to client 120 via MCDN 100, and may be shown to the user as an element of the user interface. The user interface may include a plurality of menu items arranged according to one or more menu layouts, which enable a user to operate MHD 125. The user may operate the user interface, including EPG 316, using remote control 128 (see FIG. 2) in conjunction with RC module 314. In some embodiments, service alert application 152, in conjunction with EPG 316 and service alert monitoring 318, provides functionality to report a disruption of a multimedia program, as will now be described in further detail below.

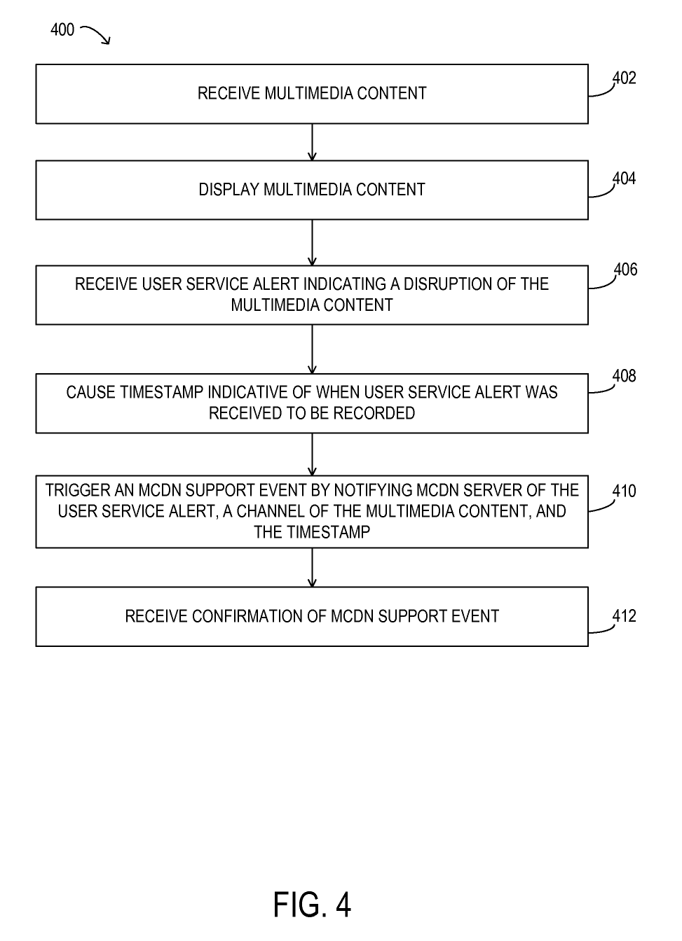

Turning now to FIG. 4, an embodiment of method 400 for incident reporting is illustrated. In one embodiment, method 400 is performed by a client device on the MCDN, such as MHD 125. Method 400 may also be performed in conjunction with service alert application 152. It is noted that certain operations described in method 400 may be optional or may be rearranged in different embodiments.

Multimedia content may be received (operation 402). In one embodiment, the multimedia content includes IPTV channels, which are received by a user of an MCDN client. The multimedia content may be displayed (operation 404). During display, user input for selecting a viewing channel displaying a desired program may be received. The user input may be received from a remote control device for selecting channels. The remote control device may be configured to operate an EPG for displaying and selecting channels, such as EPG 316. The viewing channel may begin to display the desired program in operation 404.

A user alert indicating a disruption of the multimedia content may be received (operation 406). The user alert may be received as a result of a corresponding option in EPG 316, such as a menu item, a text field, or a virtual button, being selected. In some embodiments, a physical button on a remote control device is provided for generating and sending user alerts. For example, remote control device 128, which may be a wireless communications device, may be equipped with a service alert button or indicator, which the user may operate when a disruption occurs. Thus, remote control device 128 may generate the user alert and transmit information associated with the user alert to a receiver on MHD 125 or display 126.

Then, method 400 may cause a timestamp indicative of when the user service alert was received to be recorded (operation 408). The timestamp may be generated by MHD 125 when the user alert is received, for example, in operation 406. In certain cases, the timestamp is included in the information generated with the user alert, for example, by remote control 128. Client 120 may record the timestamp locally or on a network server. In one embodiment, service alert application 152 executing on application server 150 causes the timestamp to be stored by database server 190. In addition to the timestamp, an identity of client 120 and/or an identifier for the viewing channel may also be recorded in operation 408.

An MCDN support event may then be triggered by notifying an MCDN server of the user service alert, a channel of the multimedia content, and the timestamp (operation 410). In some cases, the MCDN server is notified using references to the information recorded in operation 408. Triggering a support event may include opening a support ticket in a trouble ticketing system (not shown in FIGS. 1-3), which may be used for tracking and statistical purposes. It is noted that the MCDN support event may be automatically triggered in operation 410 in response to the user service alert.

Once the MCDN support event has been triggered, further actions, such as network diagnosis, debugging, or researching the cause of the disruption, may be initiated. The network diagnosis may include querying packet routing devices in the MCDN, for example, to check for impediments to network traffic flow. The user issuing the user service alert may be contacted to clarify the disruption or to provide further information. In some cases, additional operations (not shown in FIG. 4) may be performed, for example, to filter user service alerts, or to combine multiple user service alerts into a single support event.

A confirmation of the MCDN support event may then be received (operation 412). In certain embodiments, additional information may be provided along with the confirmation that the support event has been generated. The additional information may include status information for the support event. The confirmation may be displayed to the user, for example, using EPG 316.

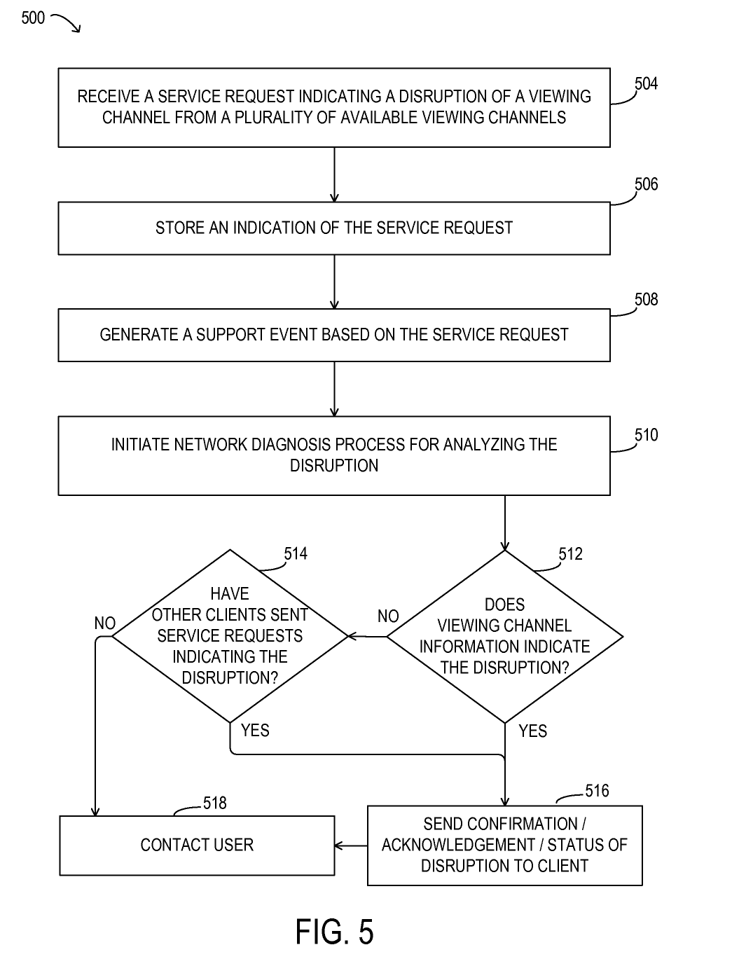

Turning now to FIG. 5, an embodiment of method 500 for incident reporting is illustrated. In one embodiment, method 500 is performed by service alert application 152 on application server 150. Method 500 may also be performed in conjunction with a client device on the MCDN, such as MHD 125. It is noted that certain operations described in method 500 may be optional or may be rearranged in different embodiments.

A service request indicating a disruption of a viewing channel from a plurality of available viewing channels may be received (operation 504). In some instances, the service request is received from a user receiving multimedia content at an MCDN client, and may be relayed by CPE over the MCDN. An indication of the service request may then be stored (operation 506). As mentioned above, additional information, such as a client identity, a program or channel identifier, and a timestamp for the disruption, may be stored along with the indication of the service request.

A support event may be generated based on the service request (operation 508). Additional logic may be applied to determine if the service request qualifies for generating a support event in operation 508. For example, information about the client or the user, such as a history of incident reporting, may be factored in the determination to generate a support event. Other information, such as network outage reports, or environmental conditions, may also be used in the determination to generate a support event, or the type of support event generated. The validity of the service request may be confirmed, including comparing information for the viewing channel with the service request, prior to generating the support event. As discussed with respect to method 400 (see FIG. 4), a support event may cause additional actions, e.g., diagnosis, debugging, analysis, etc., with respect to network operations to be initiated.

A network diagnosis process for analyzing the disruption may be initiated (operation 510). The network diagnosis process may involve various operations, including but not limited to verifying the disruption, determining the scope and/or severity of the disruption, performing quality of service tests on the network, analyzing network logs, and corroborating different incident reports. In some cases, information specific to the viewing channel on which the disruption was reported may be analyzed.

A decision may then be made if viewing channel information indicates the disruption (operation 512). The viewing channel information may be analyzed to determine if the disruption can be confirmed, or if the cause of the disruption can be identified. If the result of operation 512 is NO, then a further decision may be made if other clients have sent service requests indicating the disruption (operation 514). Service requests from a plurality of clients may be corroborated in location, time, or by viewing channel to determine the extent, and so possible the cause, of the disruption. If the result of operation 512 is YES or the result of operation 514 is YES, then a confirmation/acknowledgement/status of the disruption may be sent to the client (operation 516). After operation 516, or if the result of operation 514 is NO, then method 500 may continue by contacting the user (operation 518). The user may be contacted to discuss the reported incident, and to exchange additional information. The user may be contacted via email, text message, telephone call, via the MCDN, or a combination thereof.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for reporting incidents over a multimedia content distribution network (MCDN), comprising:
receiving multimedia content from the MCDN;
displaying the multimedia content;
receiving a user service alert indicative of a disruption of the multimedia content; and
causing a timestamp indicative of when the user service alert was received to be recorded.

2. The method of claim 1, further comprising:
in response to said receiving the user service alert, triggering an MCDN support event, including sending a notification of the user service alert, a channel associated with the multimedia content, and the timestamp.

3. The method of claim 2, wherein said triggering includes notifying an MCDN server.

4. The method of claim 1, wherein the user service alert is received from a remote control device configured to send an indication of a desired channel for viewing, and further comprising:
responsive to user input, selecting the desired channel from a plurality of channels associated with the multimedia content.

5. The method of claim 4, wherein the remote control device is configured to operate with an electronic programming guide (EPG) for viewing and selecting multimedia content available from the MCDN.

6. The method of claim 5, wherein said receiving the user service alert includes receiving a response to a menu option in the EPG.

7. The method of claim 1, wherein the user service alert is received from a remote control device.

8. The method of claim 7, wherein the remote control device is a wireless communications device, and wherein the user service alert is wirelessly received.

9. A system for generating support events over a multimedia content distribution network (MCDN), comprising:
a processor; and
memory media accessible to the processor, including processor executable instructions to:
send multimedia content to a client of the MCDN, including a plurality of viewing channels;
receive a service request via the MCDN from the client indicating a disruption of a viewing channel from the plurality of viewing channels; and
generate a support event based on the service request.

10. The system of claim 9, wherein the service request is based on user input received by the client.

11. The system of claim 10, further comprising processor executable instructions to:
send a confirmation to the client that the support event has been generated.

12. The system of claim 10, further comprising processor executable instructions to:
store information about the service request.

13. The system of claim 12, wherein the information includes at least one of information indicating a network identity of the client and information indicating an identity of the user.

14. The system of claim 9, wherein the service request includes information specifying the viewing channel and a timestamp indicative of when the service request was received.

15. The system of claim 9, wherein said instructions to generate the support event include instructions executable to cause an MCDN service provider to perform a network diagnosis routine for the disruption.

16. The system of claim 15, wherein the network diagnosis routine includes querying packet routing devices on the MCDN.

17. The system of claim 9, further comprising processor executable instructions to:
confirm the validity of the service request, wherein information for the viewing channel is compared with the service request.

18. The system of claim 17, wherein the information for the viewing channel includes information collected from a plurality of clients of the MCDN.

19. Computer-readable memory media, including instructions for delivering multimedia content over a multimedia content distribution network (MCDN), said instructions executable to:
respond to a user service alert indicating a disruption of a viewing channel by generating a support event, wherein the viewing channel is one of a plurality of viewing channels made available to a client of the MCDN; and
output a confirmation of the support event to the client.

20. The memory media of claim 19, wherein the user service alert includes information specifying the viewing channel and a timestamp indicative of when the user service alert was received.

21. The memory media of claim 19, wherein said instructions to respond to the user service alert include instructions executable to cause an MCDN service provider to perform a network diagnosis routine for the disruption.

22. The memory media of claim 21, further comprising instructions executable to:
output status information for the network diagnosis routine to the client.

23. The memory media of claim 19, wherein said instructions to respond to the user service alert include instructions executable to contact a user of the client.

24. The memory media of claim 23, wherein said instructions executable to contact the user of the client include instructions executable to send a text message to the user.

25. The memory media of claim 23, wherein said instructions executable to contact the user of the client include instructions executable to initiate a telephone call to the user.
